(19) United States
(12) Patent Application Publication
(10) Pub. No.: US 2019/0097917 A1
(43) Pub. Date: Mar. 28, 2019

(54) NETWORK SYSTEM, NETWORK CONTROLLER, METHOD, AND PROGRAM

(71) Applicant: NEC Corporation, Minato-ku, Tokyo (JP)

(72) Inventors: Yohei IIZAWA, Tokyo (JP); Kazuya SUZUKI, Tokyo (JP)

(73) Assignee: NEC Corporation, Minato-ku, Tokyo (JP)

(21) Appl. No.: 16/088,110

(22) PCT Filed: Mar. 23, 2017
(86) PCT No.: PCT/JP2017/011656

§ 371 Date: Sep. 25, 2018

(30) Foreign Application Priority Data
Mar. 30, 2016 (JP) 2016-068453

(51) Int. Cl. H04L 12/707; H04L 12/703

(52) U.S. Cl. CPC H04L 45/22; H04L 45/28

(57) ABSTRACT

A network system according to one example embodiment of the present invention in a multilayer network having an upper layer and a lower layer each including a plurality of links in which each of the plurality of links on the upper layer is associated with a plurality of paths on the lower layer, and the network system includes: a candidate link selection unit that, when at least one path of the plurality of paths on the lower layer associated with one link of the plurality of links on the upper layer does not overlap with an active path on the upper layer, selects the one link as a candidate link; and a backup path determination unit that uses the candidate link to determine a backup path for the active path on the upper layer.

### TECHNICAL FIELD

The present invention relates to a network system, a network controller, a method, and a program, and more specifically, to a network system, a network controller, a method, and a program that perform calculation of a backup path for an active path in a multilayer network.

### BACKGROUND ART

In recent years, a multilayer network has been developed as a next generation network. The multilayer network includes a network having a plurality of layers (hierarchies), and networks on respective layers use a common physical network but have logically different topologies. A plurality of layers included in the multilayer network are ordered such that a layer closer to the physical network is located in a lower level. Among such a plurality of layers, a layer located on a relatively higher level is referred to as an upper layer, and a layer located on a relatively lower level is referred to as a lower layer.

Further, as a failure countermeasure technology of the network, a backup configuration (also referred to as path protection) is employed. In the backup configuration, at least two paths including an active path (referred to as a currently used path, an active path) and a backup path (referred to as a reserve path, a standby path) are set between a source node and a destination node. The active path and the backup path include links that connect a plurality of nodes to a node, respectively. Communication during a normal state is performed by using an active path, and the communication is switched to a backup path when a failure occurs in the active path. With such a configuration, it is possible to quickly continue communication without waiting for recovery from the failure.

Patent Literature 1 discloses an art that selects an appropriate backup path for an active path based on a Shared Risk Link Group (SRLG). The SRLG is a set of a plurality of links in which failures are likely to occur at the same time because the links share a physical component, and different SRLG IDs are set on an SRLG basis. For example, the same SRLG is provided to a plurality of links that run physically the same tunnel. The art disclosed in Patent Literature 1 suppresses failures from occurring at the same time in an active path and a backup path by excluding, from backup paths, a link which includes even one SRLG ID of a link used by the active path.

Non Patent Literature 1 discloses the specification of an SRLG as RFC4203. Non Patent Literature 1 defines that a plurality of SRLG values (SRLG IDs) belonging to a single link are represented in a list form in which these values are simply listed.

### CITATION LIST

### Patent Literature

PTL 1: Japanese Patent Application Laid-Open No. 2006-135686

### Non Patent Literature

NPL 1: “OSPF Extensions in Support of Generalized Multi-Protocol Label Switching (GMPLS)”, [online], October 2005, The Internet Engineering Task Force (IETF) [searched on Mar. 10, 2016], Internet <URL: https://www.ietf.org/rfc/rfc4203.txt>, Page 3

NPL 2: “OpenFlow Switch Specification Version 1.0.0 (Wire Protocol 0x01)”, [online], Dec. 31 2009, Open Networking Foundation (ONF), [searched on Mar. 10, 2016], Internet <URL: https://www.opennetworking.org/images/stories/downloads/sdn-resources/onf-specifications/openflow/openflow-spec-v1.0.0.pdf>

### SUMMARY OF INVENTION

### Technical Problem

When a backup configuration is implemented in a multilayer network, an active path and a backup path are selected for each layer. Based on the specification disclosed in Non Patent Literature 1, however, it cannot be distinguished that each SRLG ID is used for which of the active path or the backup path. As a result, when a backup path on an upper layer is calculated using the art of Patent Literature 1, links on a lower layer that are supposed to be suitable for a backup path of an upper layer (that is, links on which a failure is less likely occur at the same time as the active path) may include an SLG ID which overlaps with the active path on the upper layer and therefore may be excluded.

The conventional calculation method of a backup path will be described using a specific example. FIG. 11A to FIG. 11C are schematic diagrams of an active path and a backup path in a multilayer network. FIG. 11A illustrates an upper layer, and there are a link 1 and a link 2 between the node N1 and the node N2. FIG. 11B and FIG. 11C illustrate lower layers, and there are a plurality of links among nodes N3 to N6. Each link of the lower layer is provided with an SRLG ID (1 to 13).

When the link 1 is an active path on the upper layer, it is examined whether or not the link 2 is suitable for a backup path. As illustrated in FIG. 11B, the link 1 on the upper layer is associated with an active path (broken line) of the SRLG IDs 1, 2, and 3 on the lower layer and a backup path (one-dot-chain line) of the SRLG IDs 11, 12, and 13. On the other hand, as illustrated in FIG. 11C, the link 2 on the upper layer is associated with an active path (broken line) of the SRLG IDs 6, 7, and 8 on the lower layer and a backup path (one-dot-chain line) of the SRLG IDs 11, 12, and 13.

For example, with respect to the link 1 that is in the active path on the upper layer, even when failures occur on both of the SRLG IDs 1, 2, and 3, which are on the active path on the lower layer, and the SRLG IDs 11, 12, and 13, which are on the backup path on the lower layer, the SRLG IDs 6, 7, and 8, which are on the active path on the lower layer, are in an alive state in the link 2 on the upper layer. Therefore, the link 2 on the upper layer is suitable as a backup path for the link 1 that is in the active path on the upper layer.

In the specification disclosed in Non Patent Literature 1 as described above, however, since the SRLG IDs are represented as a simple list, it is not distinguished that respective SRLG IDs belongs to which of the active path or the backup path. It is thus defined that the link 1 on the upper layer includes the SRLG IDs 1, 2, 3, 11, 12, and 13 and the link 2 on the upper layer includes the SRLG IDs 6, 7, 8, 11, 12, and 13. When the art of Patent Literature 1 is implemented using such a definition, since the link 2 on the upper layer includes the SRLG IDs 11, 12, and 13 that are the same as the link 1 on the upper layer, it is determined that the link 2 is not suitable for the backup path on the link 1 on the upper layer.

As discussed above, conventionally, no consideration is made for a backup configuration on a plurality of layers, and the link 2 that is supposed to be suitable as a backup path may be excluded. Therefore, since a new link that is different from the link 2 is added for setting of the backup path for the link 1, this causes a problem of excessive resources being required.

The present invention has been made in view of the problem described above and intends to provide a network system, a network controller, a method, and a program that can set a suitable backup path on an upper layer taking the backup configuration on a lower layer into consideration in a multilayer network.

### Solution to Problem

The first example aspect of the present invention is a network system in a multilayer network having an upper layer and a lower layer each including a plurality of links in which each of the plurality of links on the upper layer is associated with a plurality of paths on the lower layer, and the network system includes: a candidate link selection unit that, when at least one path of the plurality of paths on the lower layer associated with one link of the plurality of links on the upper layer does not overlap with an active path on the upper layer, selects the one link as a candidate link; and a backup path determination unit that uses the candidate link to determine a backup path for the active path on the upper layer.

The second example aspect of the present invention is a network controller in a multilayer network having an upper layer and a lower layer each including a plurality of links in which each of the plurality of links on the upper layer is associated with a plurality of paths on the lower layer, and the network controller includes: a candidate link selection unit that, when at least one path of the plurality of paths on the lower layer associated with one link of the plurality of links on the upper layer does not overlap with an active path on the upper layer, selects the one link as a candidate link; and a backup path determination unit that uses the candidate link to determine a backup path for the active path on the upper layer.

The third example aspect of the present invention is a method in a multilayer network having an upper layer and a lower layer each including a plurality of links in which each of the plurality of links on the upper layer is associated with a plurality of paths on the lower layer, and the method includes steps of: when at least one path of the plurality of paths on the lower layer associated with one link of the plurality of links on the upper layer does not overlap with an active path on the upper layer, selecting the one link as a candidate link; and determining a backup path for the active path on the upper layer by using the candidate link.

The fourth example aspect of the present invention is a program that, in a multilayer network having an upper layer and a lower layer each including a plurality of links in which each of the plurality of links on the upper layer is associated with a plurality of paths on the lower layer, causes a computer to execute steps of: when at least one path of the plurality of paths on the lower layer associated with one link of the plurality of links on the upper layer does not overlap with an active path on the upper layer, selecting the one link as a candidate link; and determining a backup path for the active path on the upper layer by using the candidate link.

### Advantageous Effects of Invention

According to the present invention, in a multilayer network in which a plurality of paths including an active path and a backup path are set on the lower layer, when at least one path of the plurality of paths does not overlap with the active path on the upper layer, a link on the upper layer associated with the at least one path is selected as a candidate link of the backup path on the upper layer. Thereby, in determination of a backup path on the upper layer, a suitable backup path on the upper layer can be set by taking the backup configuration on the lower layer into consideration.

### BRIEF DESCRIPTION OF DRAWINGS

FIG. 1 is a schematic diagram of a network system according to a first example embodiment.

FIG. 2 is a general configuration diagram of the network system according to the first example embodiment.

FIG. 3 is a schematic diagram illustrating an association relationship between links and IDs on a lower layer according to the first example embodiment.

FIG. 4A is a schematic diagram illustrating a backup configuration of the lower layer according to the first example embodiment.

FIG. 4B is a schematic diagram illustrating a backup configuration of the lower layer according to the first example embodiment.

FIG. 4C is a schematic diagram illustrating a backup configuration of the lower layer according to the first example embodiment.

FIG. 5 is a schematic diagram illustrating an association relationship between links on an upper layer and groups on a lower layer according to the first example embodiment.

FIG. 6 is a block diagram of the network system according to the first example embodiment.

FIG. 7 is a schematic diagram illustrating a calculation result of backup paths by the network system according to the first example embodiment.

FIG. 8 is a diagram illustrating a flowchart of a backup path determination method according to the first example embodiment.

FIG. 9 is a schematic diagram illustrating an association relationship between links on an upper layer and groups on a lower layer according to a second example embodiment.

FIG. 10 is a general configuration diagram of the network system according to each example embodiment.

FIG. 11A is a schematic diagram of an active path and a backup path in an exemplary multilayer network.

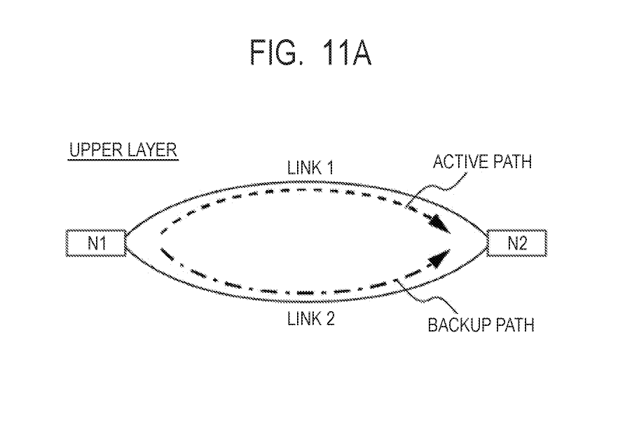

FIG. 11B is a schematic diagram of an active path and a backup path in an exemplary multilayer network.

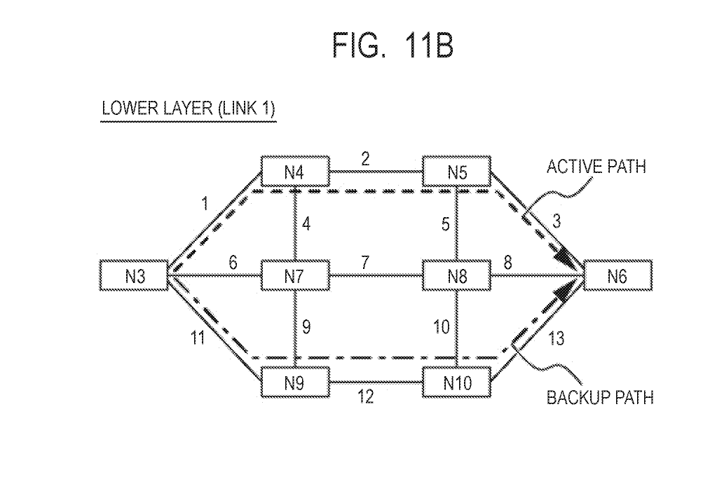

FIG. 11C is a schematic diagram of an active path and a backup path in an exemplary multilayer network.

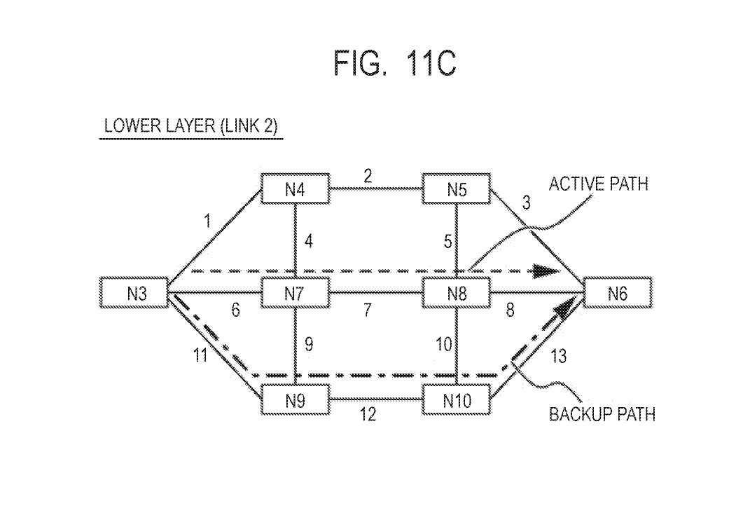

### DESCRIPTION OF EMBODIMENTS

While example embodiments of the present invention will be described below with reference to the drawings, the present invention is not limited to the present example embodiments. Note that, in the drawings described below, components having the same function are labeled with the same reference symbols, and the duplicated description thereof may be omitted.

### First Example Embodiment

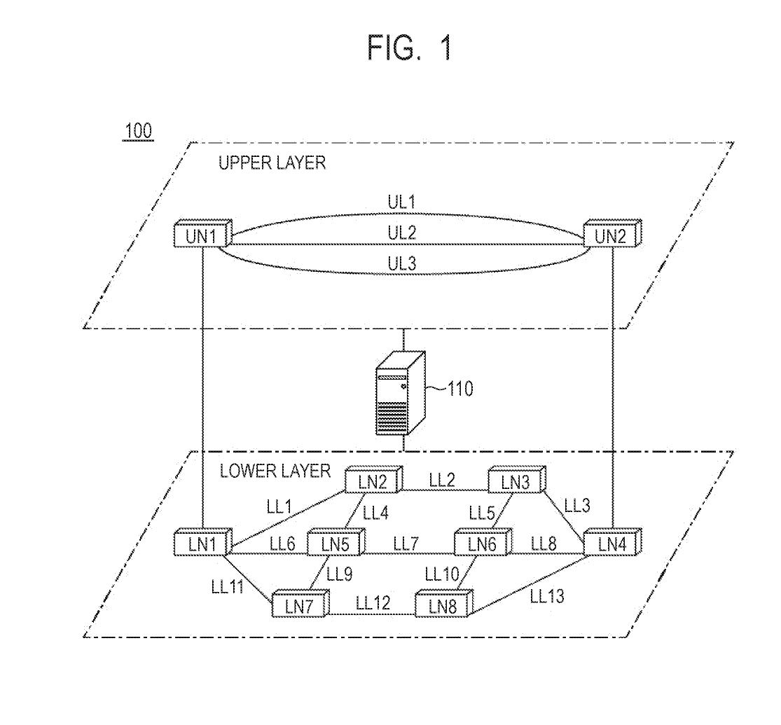

FIG. 1 is a schematic diagram of a network system 100 according to the present example embodiment. The network system 100 is a multilayer network and includes an upper layer and a lower layer. While FIG. 1 illustrates only two layers for simplicity, any two layers in a multiplayer network of the three or more layers may be used as an upper layer and a lower layer. The upper layer and the lower layer use a common physical network layer but have logically different topologies, respectively. The lower layer is configured to be closer to the physical network than the upper layer is.

The network system 100 has upper nodes UN1 and UN2 on the upper layer and has upper links UL1, UL2, and UL3 between the upper node UN1 and the upper node UN2. The upper nodes UN1 and UN2 are collectively referred to as an upper node(s) UN, and the upper links UL1, UL2, and UL3 are collectively referred to as an upper link(s) UL.

In the lower layer, the network system 100 has lower nodes LN1 to LN8 and has lower links LL1 to LL13 among the lower nodes LN1 to LN8. The lower nodes LN1 to LN8 are collectively referred to as a lower node(s) LN, and the lower links LL1 to LL13 are collectively referred to as a lower link(s) LL.

Further, the upper node UN1 and the lower node LN1 are connected to each other and the upper node UN2 and the lower node LN4 are connected to each other by links on which data can be transferred between the layers.

While the connection configuration of the upper nodes UN1 and UN2 and the upper links UL1, UL2, and UL3 and the connection configuration of the lower nodes LN1 to LN8 and the lower links LL1 to LL13 are illustrated in FIG. 1 as an example, the present example embodiment is not limited to these specific connection configurations.

Further, the network system 100 has a server 110 as a network controller. The server 110 sets a desired path by controlling the upper node UN and the lower node LN.

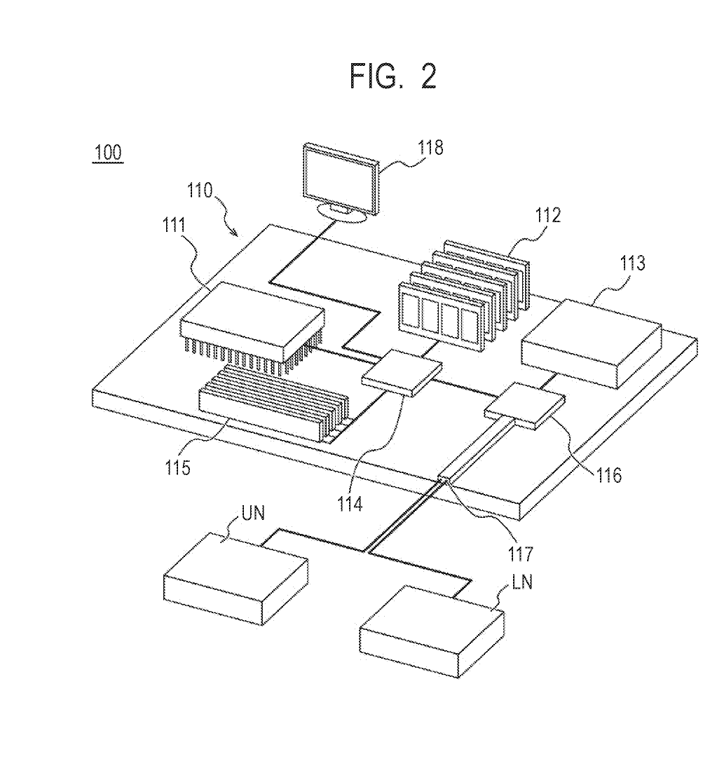

FIG. 2 is a general configuration diagram of the network system 100 according to the present example embodiment. The server 110 may be formed of a single device or may be formed of two or more physically separated devices in wired connection or wireless connection. For example, the server 110 is a laptop computer, a desktop computer, a workstation, a personal digital assistant, a server, a blade server, a mainframe, an embedded system, or the like.

The server 110 has a processor 111, memory 112, and a storage device 113. Further, the server 110 has a high-speed controller 114 including a high-speed interface and a low-speed controller 116 including a low-speed interface. The memory 112 and a high-speed expansion port 115 are connected to the high-speed controller 114. Further, a display device such as a display 118 or the like is connected to the high-speed controller 114. On the other hand, a low-speed expansion port 117 and a storage device 113 are connected to the low-speed controller 116.

The processor 111, the memory 112, the storage device 113, the high-speed controller 114, the low-speed controller 116, and the high-speed expansion port 115 are connected to each other through various buses. Further, the processor 111, the memory 112, the storage device 113, the high-speed controller 114, the low-speed controller 116, and the high-speed expansion port 115 may be implemented on a common motherboard or may be implemented in other forms as appropriate.

The processor 111 is a central processing unit (CPU), for example, and is able to process instructions executed within the server 110. Such instructions include an instruction that is used for displaying graphics information of a graphical user interface (GUI) on a display device such as the display 118 and stored in the memory 112 or the storage device 113.

Further, a plurality of processors, a plurality of busses, or a plurality of processors and a plurality of busses can be used as appropriate together with a plurality of memory devices and multiple types of memory devices. Further, a plurality of servers 110 can be connected to each device that performs a part of the necessary process. For example, a plurality of servers 110 can be connected to each other as a server bank, a group of blade servers, or a multiprocessor system.

The memory 112 stores therein information within the server 110. For example, the memory 112 may be a volatile memory unit or a non-volatile memory unit. The memory 112 may be another computer readable storage medium, such as a magnetic disk, an optical disk, or the like, for example.

The storage device 113 can configure mass storage used for the server 110. The storage device 113 may be, for example, a computer readable storage medium such as a floppy (registered trademark) disk device, a hard disk device, an optical disk device, a tape device, a solid state memory device such as a flash memory, a disk array, or the like or may include such a computer readable storage medium. The storage device 113 may be a storage area network or a device with another configuration.

The high-speed controller 114 manages processes in which the bandwidth for the server 110 is intensively used. On the other hand, the low-speed controller 116 manages processes in which the bandwidth is less intensively used. However, such allocation of the functions is a mere example, and allocation is not limited thereto. Further, a part or a whole of the high-speed controller 114 may be incorporated in the processor 111.

The high-speed controller 114 is connected to the high-speed expansion port 115 that can accept the memory 112 and various expansion cards. Further, the high-speed controller 114 is connected to the display 118 via a graphics processor or an accelerator, for example.

The low-speed controller 116 is connected to the storage device 113 and the low-speed expansion port 117. The low-speed expansion port 117 can include, for example, a communication port of various standards such as Universal Serial Bus (USB), Bluetooth (registered trademark), wired or wireless Ethernet (registered trademark), or the like. One or plurality of input/output devices such as a keyboard, a pointing device, a scanner, or the like can be connected to the low-speed expansion port 117. Further, one or plurality of network devices such as a switch, a router, or the like can be connected to the low-speed expansion port 117 via a network adapter, for example. That is, the low-speed expansion port 117 functions as a communication interface and is connected to the upper node UN and the lower node LN.

The server 110 can be implemented in many different forms without being limited to the forms described above. For example, the server 110 can be implemented in a form of a typical server or a plurality of servers in a form of a group of such servers. Further, the server 110 can be implemented as a part of the rack server system. Furthermore, the server 110 can be implemented in a form of a personal computer such as a laptop computer, a desktop computer, or the like.

Note that a part or a whole of the program executed by the processor 111 of the server 110 can be provided by a computer readable storage medium storing the above, such as a digital versatile disc-read only memory (DVD-ROM), a compact disc-read only memory (CD-ROM), a USB memory, or a flash memory.

In the present example embodiment, in order for the server 110 to control the nodes UN and LN, the OpenFlow technology disclosed in Non Patent Literature 2 is used. The OpenFlow technology is a technology to intensively manage respective nodes of the network by using a control device, perform transfer control in respective nodes, and flexibly change the network configuration. In the present example embodiment, the server 110 functions as an OpenFlow controller, and each of the nodes UN and LN functions as an OpenFlow switch.

The server 110 communicates with the nodes UN and LN by using an OpenFlow protocol. Each of the nodes UN and LN has a flow table that records a control rule such as transfer, discard, or the like of a packet. The server 110 uses the OpenFlow protocol to perform setting of a control rule to the nodes UN and LN. The nodes UN and LN perform transfer, discard, or the like of a packet in accordance with the control rule recorded in a flow table. Further, the nodes UN and LN use the OpenFlow protocol to perform inquiry to the server 110 for a process to be applied by the control rule to an unknown packet. As a method of controlling the nodes UN and LN by the server 110, any method may be used without being limited to the OpenFlow technology.

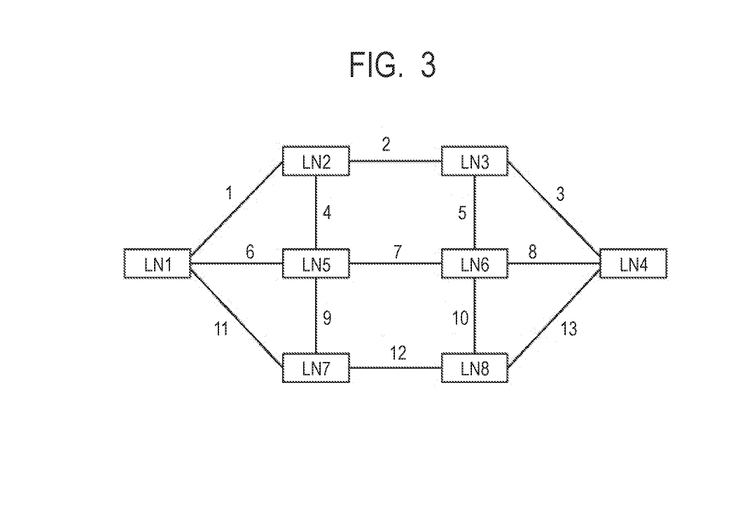

FIG. 3 is a schematic diagram illustrating an association relationship between links and IDs on the lower layer in the present example embodiment. In FIG. 3, the reference symbols LL1 to LL13 of respective lower links LL are omitted. An ID, that is, an identifier for identifying whether or not a physical component is shared for each other is provided to each lower link LL. The IDs of respective lower links LL are pre-stored in the storage device 113 of the server 110.

In the present example embodiment, a Shared Risk Link Group (SRLG) is used for identification of links that share a physical component with each other. An SRLG is a group of a plurality of links in which failures are likely to occur at the same time, and different SRLG IDs are set on an SRLG basis. For example, the same SRLG ID is provided to a plurality of links which are routed in the physically same tunnel. Each ID indicated near each lower link LL of FIG. 3 is an SRLG ID. While a single ID is associated with a single lower link LL on the lower layer for simplicity in the present example embodiment, a single ID may be associated with a plurality of lower links LL. Specifically, while the ID1 is associated with a single lower link LL1 in FIG. 3, it may be associated with two lower links LL1 and LL6.

Without being limited to the SRLG ID, any identifier that can identify lower links that share a physical component with each other may be used as an ID.

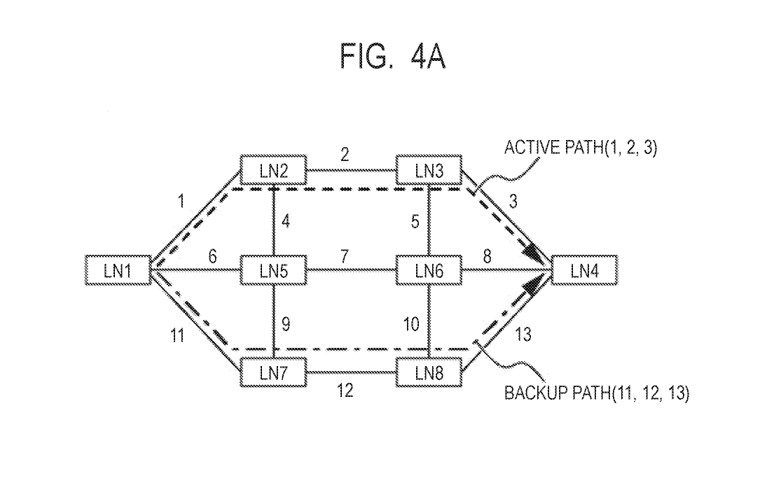

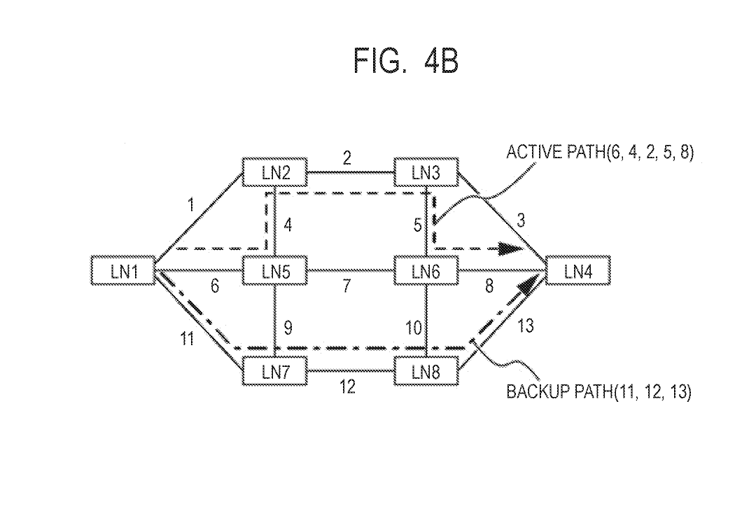

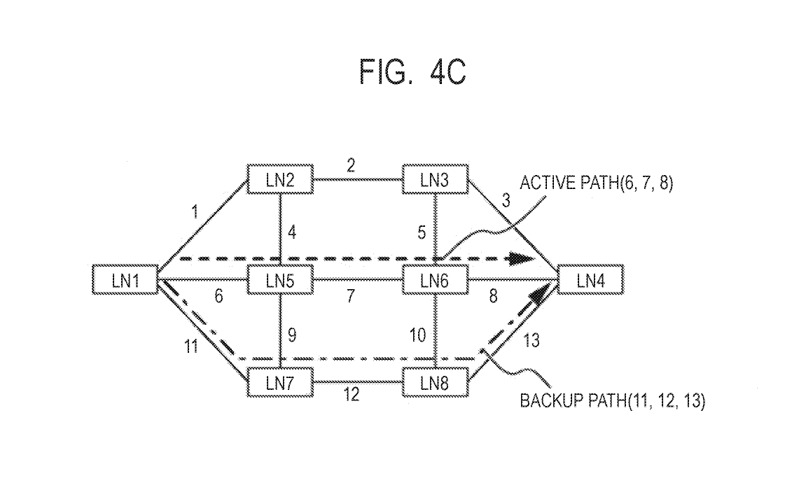

In FIG. 4A to FIG. 4C are schematic diagrams illustrating a backup configuration of the lower layer in the present example embodiment. In the present example embodiment, both of the upper layer and the lower layer form the backup configuration. In other words, a plurality of paths including an active path (broken line) and a backup path (one-dot-chain line) are set between a source node and a destination node on each of the upper layer and the lower layer. On each of the upper layer and the lower layer, communication during a normal state is performed using the active path, and the communication is switched to the backup path when a failure occurs on the active path. While a single backup path is set to a single active path in the present example embodiment, a plurality of backup paths may be set to a single active path.

In the present example embodiment, the lower node LN1 is defined as a source node and the lower node LN4 is defined as a destination node on the lower layer. The active path and the backup path on the lower layer include one or more lower links LL, respectively. As illustrated in FIG. 4A to FIG. 4C, in the present example embodiment, a group (set) in which IDs of the lower links LL are aggregated for each path of the active path and the backup path on the lower layer is defined. A group of IDs for each path of the active path and the backup path is pre-stored in the memory 112 or the storage device 113 as group information. In order to indicate a group of IDs on a path basis, such expression that lists IDs in parentheses in order will be used below. Specifically, FIG. 4A indicates that a backup path of IDs (11, 12, 13) is set for an active path of IDs (1, 2, 3). FIG. 4B indicates that a backup path of IDs (11, 12, 13) is set for an active path of IDs (6, 4, 2, 5, 8). FIG. 4C indicates that a backup path of IDs (11, 12, 13) is set for an active path of IDs (6, 7, 8).

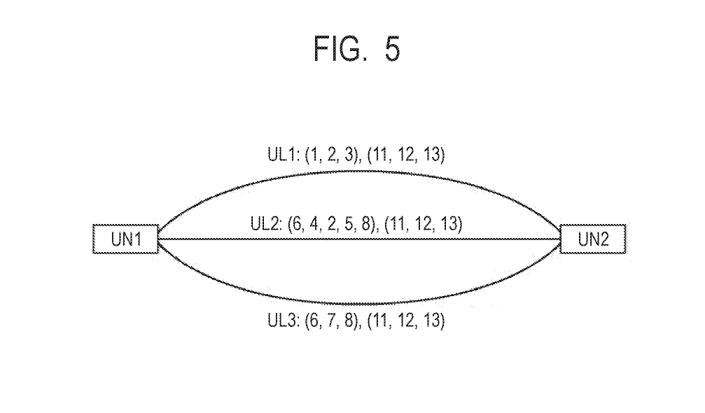

FIG. 5 is a schematic diagram illustrating an association relationship between links on the upper layer and groups on the lower layer in the present example embodiment. In the present example embodiment, the upper node UN1 is defined as a source node and the upper node UN2 is defined as a destination node on the upper layer. In this case, the upper links UL1, UL2, and UL3 between the upper nodes UN1 and UN2 are associated with at least two paths including an active path and a backup path on the lower layer, respectively, on the upper layer. Specifically, the upper link UL1 is associated with a group of the active path of IDs (1, 2, 3) and the backup path of IDs (11, 12, 13) illustrated in FIG. 4A. The upper link UL2 is associated with a group of the active path of IDs (6, 4, 2, 5, 8) and the backup path of IDs (11, 12, 13) illustrated in FIG. 4B. The upper link UL3 is associated with a group of the active path of IDs (6, 7, 8) and the backup path of IDs (11, 12, 13) illustrated in FIG. 4A.

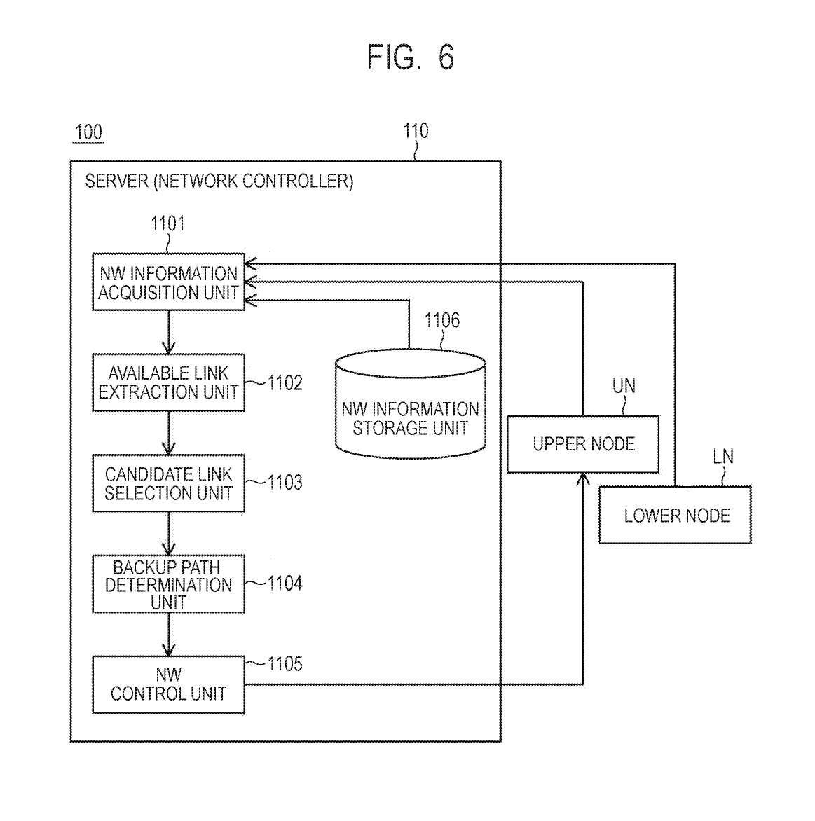

The network system 100 according to the present example embodiment calculates a suitable backup path for the active path on the upper layer in a state where a backup configuration including the active path and the backup path on the lower layer is performed in such a way. FIG. 6 is a block diagram of the network system 100 according to the present example embodiment. In FIG. 6, arrows represent main dataflows, and there may be other dataflows than those illustrated in FIG. 6. In FIG. 6, each block illustrates a configuration in a unit of function rather than in a unit of hardware (device). FIG. 6 illustrates a function according to calculation and setting of a backup path on the upper layer, and the network system 100 may have other functions.

The server 110 as a network controller has a network information acquisition unit 1101, an available link extraction unit 1102, a candidate link selection unit 1103, a backup path determination unit 1104, a network control unit 1105, and a network information storage unit 1106. The network information acquisition unit 1101, the available link extraction unit 1102, the candidate link selection unit 1103, the backup path determination unit 1104, and the network control unit 1105 are stored in the memory 112 or the storage device 113 as programs that can be executed by the processor 111. Further, the network information storage unit 1106 is a part of the memory 112 or the storage device 113. That is, in execution of the backup path determination method according to the present example embodiment, the processor 111 functions as the network information acquisition unit 1101, the available link extraction unit 1102, the candidate link selection unit 1103, the backup path determination unit 1104, and the network control unit 1105, and the memory 112 or the storage device 113 functions as the network information storage unit 1106. At least a part of these functions may be implemented as an electric circuit instead of a program.

The network information acquisition unit 1101 acquires network information from the network information storage unit 1106, the upper node UN, and the lower node LN. Specifically, the network information acquisition unit 1101 acquires information that is pre-stored in the network information storage unit 1106 and indicates an association relationship between respective upper links UL on the upper layer and a plurality of paths (the active path and the backup path) on the lower layer associated with these upper links UL. The information indicating an association information is information on IDs of respective links on the upper layer and the lower layer and information on a backup configuration including the active path and the backup path on the lower layer. Further, the network information acquisition unit 1101 may acquire information including a link cost pre-stored in the network information storage unit 1106. Furthermore, the network information acquisition unit 1101 may acquire information on failure occurrence in a node and a link from the upper node UN and the lower node LN.

The available link extraction unit 1102 extracts the upper link UL that is available between the source node and the destination node on the upper layer. The available upper link UL is an upper link UL that can connect the source node to the destination node and in which no failure occurs. Then, the available link extraction unit 1102 excludes those included in the active path on the upper layer (regardless of the ID of links on the lower layer) from the available upper links UL. For example, when the active path on the upper layer includes an upper link ULx and an upper link ULy, the upper link ULx and the upper link ULy are excluded from the available upper links UL, respectively.

The candidate link selection unit 1103 selects a candidate link according to a predetermined rule out of the available upper links UL extracted by the available link extraction unit 1102. As described above, on the lower layer, the IDs of links are aggregated in two or more groups on a path basis according to the backup configuration. In other words, a single link UL on the upper layer is associated with at least two groups including a group of active paths and a group of backup paths on the lower layer.

The candidate link selection unit 1103 performs calculation for selecting a candidate link with each available upper link UL as a calculation target. Specifically, when at least one group on the lower layer associated with an upper link UL (single link) to be calculated does not include all the IDs in the active path on the upper layer, the candidate link selection unit 1103 selects the upper link UL as a candidate link. On the other hand, when all the groups on the lower layer associated with an upper link UL to be calculated includes any of the IDs in the active path on the upper layer, the candidate link selection unit 1103 does not select the upper link UL as a candidate link.

With such calculation, when at least one path of a plurality of paths on the lower layer associated with the upper link UL to be calculated does not overlap with the active path on the upper layer at all, the candidate link selection unit 1103 can select, as a candidate link, the upper link UL to be calculated.

The backup path determination unit 1104 uses the candidate link selected by the candidate link selection unit 1103 to determine a backup path from the source node to the destination node on the upper layer. Specifically, the backup path determination unit 1104 may sum link costs of combinations of candidate links that can reach the destination node from the source node and determine, as a backup path, a combination of candidate links having the lowest total link cost. The link cost is preset for each link and stored in the network information storage unit 1106. Any other methods may be used for determination of a backup path.

The network control unit 1105 controls a multilayer network including the upper node UN based on the backup path determined by the backup path determination unit 1104. Specifically, when some failure occurs on the active path, the network control unit 1105 uses the OpenFlow protocol described above to set a new control rule of transferring a packet in a flow table of the upper node UN by using the backup path. Thereby, communication can be performed using the backup path determined by the backup path determination unit 1104 on the upper layer.

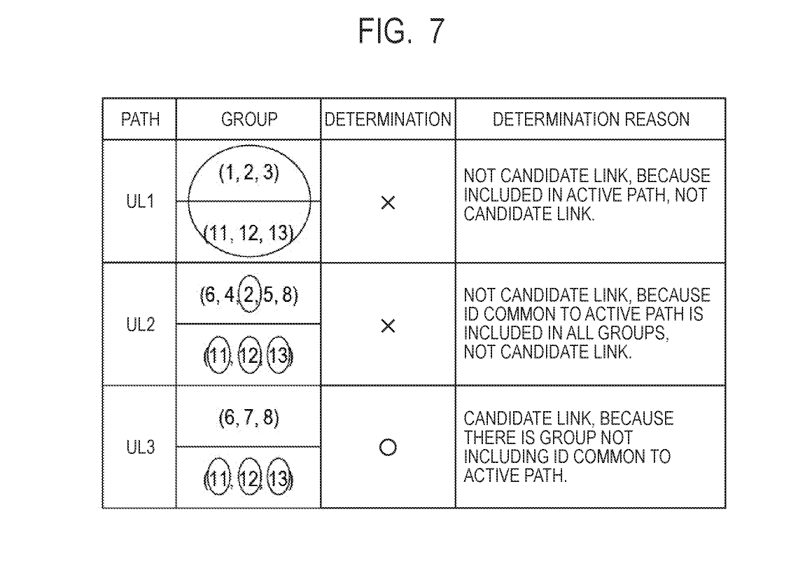

FIG. 7 is a schematic diagram illustrating a calculation result of backup paths by the network system 100 according to the present example embodiment. The calculation result of backup paths in FIG. 7 is based on the example of FIG. 5. In the example of FIG. 5, the available upper links UL1, UL2, and UL3 exist between the upper node UN1 that is the source node and the upper node UN2 that is the destination node, and the upper link UL1 is the active path on the upper layer. First, since the active path on the upper layer includes only one upper link UL1, the available link extraction unit 1102 excludes the upper link UL1 from the available upper links UL1, UL2, and UL3.

Next, since an ID common to the active path (that is, the upper link UL1) is included in all the groups, the upper link UL2 is excluded from available upper links by the candidate link selection unit 1103. Specifically, since ID2 included in the upper link UL1 is included in the first group (6, 4, 2, 5, 8) of the upper link UL2, and IDs 11, 12, and 13 included in the upper link UL1 are included in the second group (11, 12, 13) of the upper link UL2, the upper link UL2 is not selected as a candidate link.

Next, the upper link UL3 has at least one group that does not include an ID common to the active path (that is, the upper link UL1) and thus selected as a candidate link by the candidate link selection unit 1103. Specifically, IDs 11, 12, and 13 included in the upper link UL1 are included in the second group (11, 12, 13) of the upper link UL3, but none of the IDs included in the upper link UL1 is included in the first group (6, 7, 8) of the upper link UL3, and thus the upper link UL3 is selected as a candidate link. In other words, even if a failure occurs in any location of the IDs 1, 2, 3, 11, 12, and 13 of the active path in the upper link UL1 on the lower layer, the first group (6, 7, 8) of the upper link UL3 is alive on the lower layer. Thus, the candidate link selection unit 1103 determines that the upper link UL3 is suitable as a backup path for the upper link UL1 in the active path on the upper layer.

Then, the backup path determination unit 1104 uses the selected candidate link to determine a backup path on the upper layer. Since a single link is used for connection from the upper node UN1 that is the source node to the upper node UN2 that is the destination node for simplicity in the example of FIG. 5, the upper link UL3 selected as the candidate link is determined as a backup path. When a plurality of links are used for connection from the source node to the destination node on the upper layer, a combination of candidate links that can reach the destination node from the source node is determined as a backup path.

Note that, in the art disclosed in Patent Literature 1 that is a prior art, since IDs of the active path and the backup path on the lower layer are not distinguished, the upper link UL3 having the IDs 2, 11, 12, and 13 common to the upper link UL1 that is the active path is not used for a backup path. As a result, the upper link UL3 that is supposed to be available as a backup path is excluded, and an additional link is further required as a backup path.

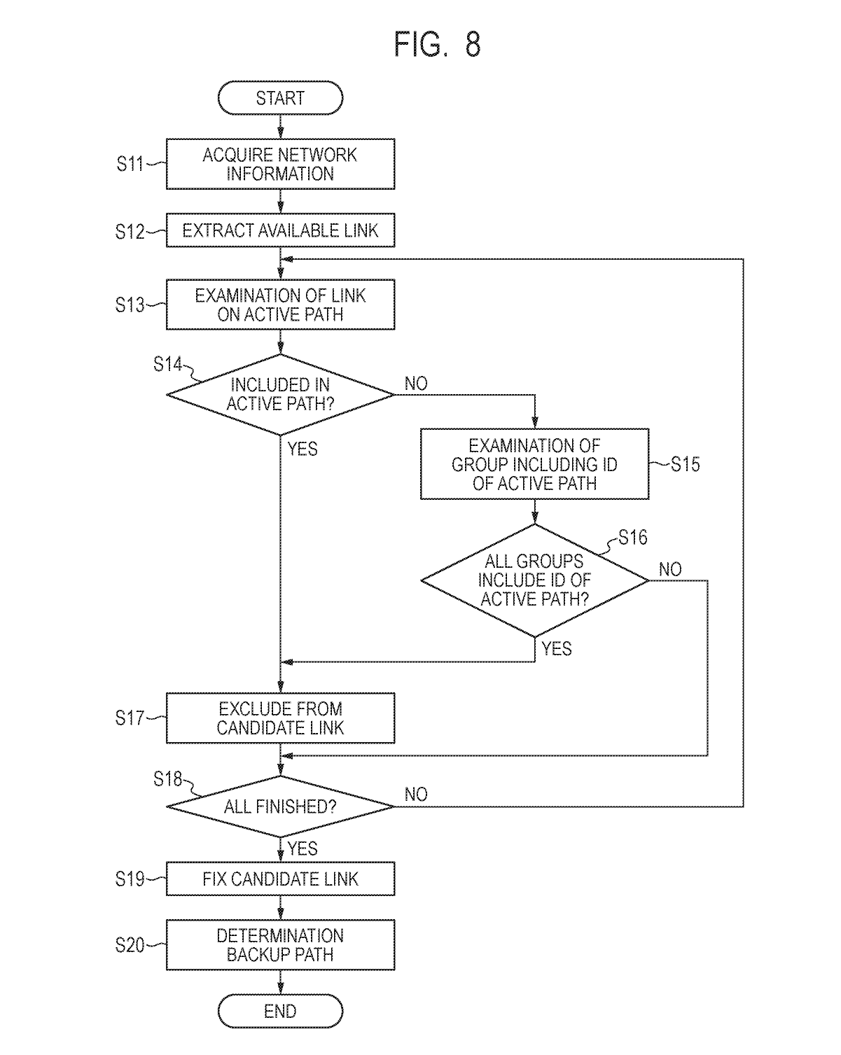

FIG. 8 is a diagram illustrating a flowchart of a backup path determination method according to the present example embodiment. The backup path determination method is started when a new communication is needed or when a path is changed due to some failure, for example. The backup path determination method may be started automatically when a start condition is satisfied or started in response to an instruction from a user.

First, the network information acquisition unit 1101 acquires network information from the network information storage unit 1106, the upper node UN, and the lower node LN (step S11). The network information includes information indicating an association relationship between respective upper link UL on the upper layer and a plurality of paths on the lower layer associated with the upper link UL and, more specifically, includes information on the ID of each link on the upper layer and the lower layer, information on the backup configuration on the lower layer (that is, group information), information on the link cost, and information on failure occurrence.

The available link extraction unit 1102 extracts available upper links between the source node and the destination node on the upper layer and defines them as available links (step S12). The available link is an upper link that may connect the source node to the destination node and in which no failure occurs. The following processes are sequentially performed while available links are to be examined one by one.

The available link extraction unit 1102 examines whether or not an available link to be examined is included in the active path on the upper layer (step S13). If an available link to be examined is included in the active path on the upper layer (step S14, YES), the available link is excluded from candidate links that can be used for the backup path (step S17).

If an available link to be examined is not included in the active path on the upper layer (step S14, NO), the candidate link selection unit 1103 examines whether or not each group of the lower layer associated with the available link to be examined includes any of the IDs of the active paths on the upper layer (step S15). If all the groups of the lower layer associated with an available link to be examined includes any of the IDs of the active paths on the upper layer (step S16, YES), the available link is excluded from candidate links that can be used for the backup path (step S17). If at least one group of the lower layer associated with an available link to be examined includes none of the IDs of the active paths on the upper layer (step S16, NO), the available link is held as a candidate link that can be used for the backup path.

If examination is not finished for all the available links (step S18, NO), the processes from step S13 are repeated while the next available link is to be examined. If examination is finished for all the available links (step S18, YES), the held available link is fixed as a candidate link (step S19).

The backup path determination unit 1104 uses the candidate link fixed in step S19 to determine a backup path from the source node to the destination node on the upper layer (step S20). For example, the backup path determination unit 1104 sums link costs acquired in step S11 for each combination of candidate links from the source node to the destination node on the upper layer and determines the combination of candidate links having the lowest total link cost as a backup path on the upper layer. Then, the network control unit 1105 can control the upper node UN based on the backup path determined by the backup path determination unit 1104.

The processor 111 of the server 110 is a subject of each step (process) included in the backup path determination method illustrated in FIG. 8. That is, the processor 111 reads the program for executing the backup path determination method illustrated in FIG. 8 from the memory 112 or the storage device 113, executes the program to control respective units of the server 110, and thereby performs the backup path determination method illustrated in FIG. 8.

Note that examination of links of the active path in steps S13 to S14 in the available link extraction unit 1102 may be omitted from the flowchart of FIG. 8. This is because, even if not excluded by the available link extraction unit 1102, a link included in the active path on the upper layer is automatically excluded from candidate links through examination of the group including the IDs of the active path in steps S15 to S16. As in the case of FIG. 8, a link included in the active path on the upper layer is excluded in advance in steps S13 to S14 from the link to be calculated, and thereby calculation amount required for examination of a group including the IDs of the active path can be reduced.

In the conventional backup path calculation, since no consideration is made for the fact that both the upper layer and the lower layer have backup configurations, a link on the lower layer that is supposed to be suitable for a backup path on the upper layer is excluded in calculation of a backup path on the upper layer. In contrast, the network system 100 according to the present example embodiment defines a group of IDs on a path basis of the backup configuration of the lower layer and selects a link on the lower layer having even one group which does not include all the IDs of the active path on the upper layer in calculation of a backup path on the upper layer. Thereby, when a failure occurs on the active path on the upper layer, a backup path on the upper layer can be suitably determined so that at least one of the active path and the backup path on the lower layer is alive. As a result, addition of an excessive link is no longer necessary, and resources required for a backup configuration can be reduced.

### Second Example Embodiment

In the present example embodiment, in determination of a backup path after selection of candidate links, a use of the ID and information on the group of backup configurations enables determination of a more suitable backup path. The present example embodiment uses the same network system 100 as that of the first example embodiment, and only the calculation method of a backup path performed by the backup path determination unit 1104 is different.

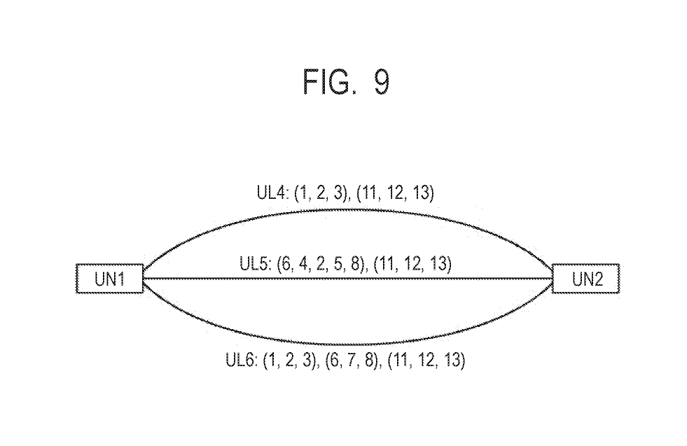

FIG. 9 is a schematic diagram illustrating an exemplary association relationship between links on the upper layer and groups on the lower layer. In FIG. 9, the upper links UL4, UL5, and UL6 are candidate links that can be used as a backup path for a not shown active path.

In FIG. 9, the upper link UL4 is associated with the group of IDs (1, 2, 3) and the group of IDs (11, 12, 13) of the lower layer. The upper link UL5 is associated with the group of IDs (6, 4, 2, 5, 8) and the group of IDs (11, 12, 13) of the lower layer. The upper link UL6 is associated with the group of IDs (1, 2, 3), the group of IDs (6, 7, 8), and the group of IDs (11, 12, 13) of the lower layer.

First, the backup path determination unit 1104 according to the present example embodiment performs calculation of a backup path based on the number of IDs included in the upper link UL (that is, the number of SRLG IDs on the lower layer). Specifically, the backup path determination unit 1104 performs weighting so that a smaller ID number included in the upper link UL results in a smaller link cost. Thereby, the upper link UL having a smaller number of IDs is more likely to be selected as a backup path. When the number of IDs of an upper link UL is small, the number of physical paths through which the upper link UL runs is small, and thus a failure is less likely to occur. Therefore, a use of the upper link UL having a smaller number of IDs as a backup path can reduce an occurrence ratio of a failure on the upper layer.

For example, while the upper link UL4 includes six IDs, the upper link UL5 includes eight IDs. Thus, since the number of IDs of the upper link UL4 is smaller than the number of IDs of the upper link UL5, the backup path determination unit 1104 determines that the upper link UL4 is more suitable for the backup path.

Second, the backup path determination unit 1104 according to the present example embodiment performs calculation of a backup path based on the number of groups included in the upper link UL (that is, the number of associated paths on the lower layer). Specifically, the backup path determination unit 1104 performs weighting so that a larger number of groups of the upper links UL results in a smaller link cost. Thereby, the upper link UL having a larger number of groups is more likely to be selected as a backup path. When the number of groups of an upper link UL is large, the number of backup paths provided on the lower layer for the upper link UL is large, and thus it can be said that, even when any path of the lower layer is cut, a likelihood of being able to continue communication is large. Therefore, a use of a link having a larger number of groups as a backup path can reduce an occurrence ratio of a failure on the upper layer.

For example, while the upper link UL4 includes two groups, the upper link UL6 includes three groups. Thus, since the number of groups of the upper link UL6 is larger than the number of groups of the upper link UL4, the backup path determination unit 1104 determines that the upper link UL6 is more suitable for the backup path.

The backup path determination unit 1104 may perform calculation of backup paths by determining a suitable link for using a backup path based on at least one of the number of IDs and the number of groups. Further, the backup path determination unit 1104 may perform calculation of a backup path by combining the conventional link cost to at least one of the number of IDs and the number of groups.

According to the present example embodiment, a more suitable backup path can be determined based on the number of IDs and the number of groups included in the upper link UL.

### Other Example Embodiments

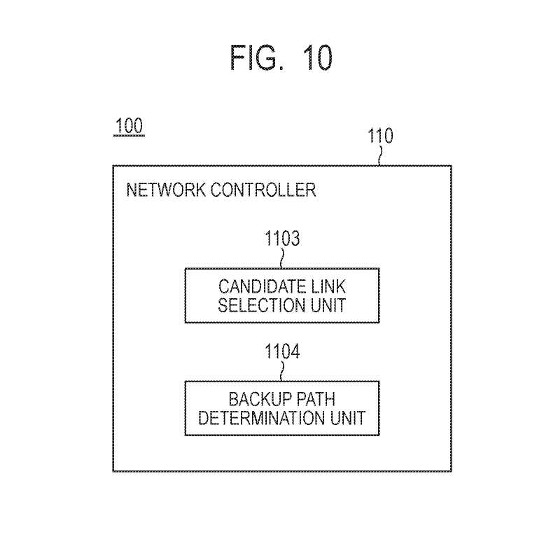

FIG. 10 is a general configuration diagram of the network system 100 according to each example embodiment described above. FIG. 10 illustrates a configuration example for implementing the function of the network system 100 determining a backup path for the active path in a multilayer network. In a multilayer network having an upper layer and a lower layer each including a plurality of links in which each of the plurality of links on the upper layer are associated with a plurality of paths on the lower layer, the network system 100 includes: the candidate link selection unit 1103 that, when at least one path of the plurality of paths on the lower layer associated with one link of the plurality of links on the upper layer does not overlap with an active path on the upper layer, selects the one link as a candidate link; and the backup path determination unit 1104 that uses the candidate link to determine a backup path for the active path on the upper layer.

The present invention is not limited to the example embodiments described above and can be properly changed within the scope not departing from the spirit of the present invention.

Further, the scope of each of the example embodiments includes a processing method that stores, in a storage medium, a program causing the configuration of each of the example embodiments to operate so as to realize the function of each of the example embodiments described above (more specifically, a program causing a computer to perform the method illustrated in FIG. 8), reads the program stored in the storage medium as a code, and executes the program in a computer. That is, the scope of each of the example embodiments also includes a computer readable storage medium. Further, each of the example embodiments includes not only the storage medium in which the program described above is stored but also the program itself.

As the storage medium, for example, a floppy (registered trademark) disk, a hard disk, an optical disk, a magneto-optical disk, a CD-ROM, a magnetic tape, a nonvolatile memory card, or a ROM can be used. Further, the scope of each of the example embodiments includes an example that operates on OS to perform a process in cooperation with another software or a function of an add-in board without being limited to an example that performs a process by an individual program stored in the storage medium.

The whole or part of the example embodiments disclosed above can be described as, but not limited to, the following supplementary notes.

(Supplementary Note 1)

A network system in a multilayer network having an upper layer and a lower layer each including a plurality of links in which each of the plurality of links on the upper layer is associated with a plurality of paths on the lower layer, the network system comprising:

a candidate link selection unit that, when at least one path of the plurality of paths on the lower layer associated with one link of the plurality of links on the upper layer does not overlap with an active path on the upper layer, selects the one link as a candidate link; and

a backup path determination unit that uses the candidate link to determine a backup path for the active path on the upper layer.

(Supplementary Note 2)

The network system according to supplementary note 1, wherein the plurality of paths on the lower layer include an active path and a backup path on the lower layer.

(Supplementary Note 3)

The network system according to supplementary note 1 or 2,

wherein the plurality of links on the lower layer are represented by identifiers indicating whether or not to share a physical component,

wherein the plurality of paths on the lower layer are represented by groups each aggregating one or more of the identifiers, and

wherein, when the groups representing the at least one paths do not include all the identifiers representing links on the lower layer associated with the active path on the upper layer, the candidate link selection unit selects the one link as the candidate link.

(Supplementary Note 4)

The network system according to supplementary note 3, wherein the identifiers are Shared Risk Link Group (SRLG) ID.

(Supplementary Note 5)

The network system according to supplementary note 3 or 4, wherein the backup path determination unit determines the backup path based on the number of the identifiers included in the candidate links.

(Supplementary Note 6)

The network system according to any one of supplementary notes 3 to 5, wherein the backup path determination unit determines the backup path based on the number of the groups included in the candidate links.

(Supplementary Note 7)

The network system according to any one of supplementary notes 1 to 6 further comprising a network control unit that controls the multilayer network based on the backup path on the upper layer determined by the backup path determination unit.

(Supplementary Note 8)

A network controller in a multilayer network having an upper layer and a lower layer each including a plurality of links in which each of the plurality of links on the upper layer is associated with a plurality of paths on the lower layer, the network controller comprising:

a candidate link selection unit that, when at least one path of the plurality of paths on the lower layer associated with one link of the plurality of links on the upper layer does not overlap with an active path on the upper layer, selects the one link as a candidate link; and

a backup path determination unit that uses the candidate link to determine a backup path for the active path on the upper layer.

(Supplementary Note 9)

A method in a multilayer network having an upper layer and a lower layer each including a plurality of links in which each of the plurality of links on the upper layer is associated with a plurality of paths on the lower layer, the method comprising steps of:

when at least one path of the plurality of paths on the lower layer associated with one link of the plurality of links on the upper layer does not overlap with an active path on the upper layer, selecting the one link as a candidate link; and

determining a backup path for the active path on the upper layer by using the candidate link.

(Supplementary Note 10)

A program that, in a multilayer network having an upper layer and a lower layer each including a plurality of links in which each of the plurality of links on the upper layer is associated with a plurality of paths on the lower layer, causes a computer to execute steps of:

when at least one path of the plurality of paths on the lower layer associated with one link of the plurality of links on the upper layer does not overlap with an active path on the upper layer, selecting the one link as a candidate link; and

determining a backup path for the active path on the upper layer by using the candidate link.

This application is based upon and claims the benefit of priority from Japanese Patent Application No. 2016-068453, filed on Mar. 30, 2016, the disclosure of which is incorporated herein in its entirety by reference.

What is claimed is:

1. A network system in a multilayer network having an upper layer and a lower layer each including a plurality of links in which each of the plurality of links on the upper layer is associated with a plurality of paths on the lower layer, the network system comprising:
a candidate link selection unit that, when at least one path of the plurality of paths on the lower layer associated with one link of the plurality of links on the upper layer does not overlap with an active path on the upper layer, selects the one link as a candidate link; and
a backup path determination unit that uses the candidate link to determine a backup path for the active path on the upper layer.

2. The network system according to claim 1, wherein the plurality of paths on the lower layer include an active path and a backup path on the lower layer.

3. The network system according to claim 1,
wherein the plurality of links on the lower layer are represented by identifiers indicating whether or not to share a physical component,
wherein the plurality of paths on the lower layer are represented by groups each aggregating one or more of the identifiers, and
wherein, when the groups representing the at least one paths do not include all the identifiers representing links on the lower layer associated with the active path on the upper layer, the candidate link selection unit selects the one link as the candidate link.

4. The network system according to claim 3, wherein the identifiers are Shared Risk Link Group (SRLG) ID.

5. The network system according to claim 3, wherein the backup path determination unit determines the backup path based on the number of the identifiers included in the candidate links.

6. The network system according to claim 3, wherein the backup path determination unit determines the backup path based on the number of the groups included in the candidate links.

7. The network system according to claim 1 further comprising a network control unit that controls the multilayer network based on the backup path on the upper layer determined by the backup path determination unit.

8. (canceled)

9. A method in a multilayer network having an upper layer and a lower layer each including a plurality of links in which each of the plurality of links on the upper layer is associated with a plurality of paths on the lower layer, the method
comprising:
when at least one path of the plurality of paths on the lower layer associated with one link of the plurality of links on the upper layer does not overlap with an active path on the upper layer, selecting the one link as a candidate link; and
determining a backup path for the active path on the upper layer by using the candidate link.

10. A non-transitory storage medium in which a program is stored, the program that, in a multilayer network having an upper layer and a lower layer each including a plurality of links in which each of the plurality of links on the upper layer is associated with a plurality of paths on the lower layer, causes a computer to execute:
when at least one path of the plurality of paths on the lower layer associated with one link of the plurality of links on the upper layer does not overlap with an active path on the upper layer, a process of selecting the one link as a candidate link; and
a process of determining a backup path for the active path on the upper layer by using the candidate link.
